(19) United States
(12) Patent Application Publication
(10) Pub. No.: US 2007/0211374 A1
(43) Pub. Date: Sep. 13, 2007

(54) Recording and/or reproducing apparatus

(75) Inventors: Otoya Sakai, Tokyo (JP); Hiroshi Ushida, Aichi (JP); Iizuka Ryoji, Saitama (JP); Kazuyoshi Tanaka, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 11/707,660

(22) Filed: Feb. 15, 2007

(30) Foreign Application Priority Data
Feb. 17, 2006 (JP) P2006-041567

(51) Int. Cl. G11B 5/008

(52) U.S. Cl. 360/96.5

(57) ABSTRACT

There is provided a recording and/or reproducing apparatus which may include a cassette insertion slot formed at a front panel, an opening/closing lid for opening/closing the cassette insertion slot, a cassette compartment, and cassette double insertion blocking means. The cassette compartment may include a cassette loading holder for loading and unloading a cassette inserted through the cassette insertion slot while pushing the opening/closing lid open inward by moving between a cassette loading position and a cassette ejecting position along a substantially L-shaped path extending horizontally and vertically. The cassette double insertion blocking means may be disposed in the cassette compartment and moved to a cassette double insertion blocking position inward of the cassette insertion slot in synchronization with an operation of loading the cassette by the cassette loading holder, thereby blocking insertion of additional cassette after one cassette is already inserted without blocking an opening/closing operation of the opening/closing lid.

### CROSS-REFERENCE TO RELATED APPLICATIONS

This application claims priority from Japanese Patent Application No. JP 2006-041567 filed in the Japanese Patent Office on Feb. 17, 2006, the entire content of which is incorporated herein by reference.

### BACKGROUND OF THE INVENTION

1. Field of the Invention

The present invention relates to a recording and/or reproducing apparatus suitable for application to a video editor (VTR for business use) such as an HDV (trade mark registered by Sony Corporation and Victor Company of Japan, Ltd.).

2. Description of Related Art

The applicant of the present invention has been granted a patent (Japanese Patent No. 3417191) on prevention of cassette double insertion by mechanically locking the opening/closing lid of a cassette insertion slot during recording and/or reproducing of a single magnetic tape cassette (hereafter, it will be referred to as simply “cassette”).

However, this technique has often caused breakdown of the opening/closing lid being mechanically weakest part of the apparatus. Namely, when trying to insert a second cassette erroneously, the user, not being able to open the opening/closing lid which he/she could otherwise open usually with a small force applied by the insertion of a cassette, mistakes the mechanically locked lid for a mechanically broken lid. Thus, he/she tries to push the opening/closing lid open through insertion of the second cassette too forcibly to break the lid.

### SUMMARY OF THE INVENTION

The present invention has been made to prevent inconvenience such as the breaking of the opening/closing lid with less mechanical strength due to cassette double insertion operation.

A recording and/or reproducing apparatus according to an embodiment of the present invention may include, a cassette insertion slot, an opening/closing lid, a cassette compartment, and cassette double insertion blocking section. The cassette insertion slot is formed at a front panel. The opening/closing lid opens/closes the cassette insertion slot. The cassette compartment may include a cassette loading holder for loading and unloading a cassette inserted through the cassette insertion slot while pushing the opening/closing lid open inward, by moving between a cassette loading position and a cassette ejecting position along a substantially L-shaped path extending in a horizontal direction and a vertical direction. The cassette double insertion blocking section may be disposed in the cassette compartment and moved to a cassette double insertion blocking position inward of the cassette insertion slot in synchronization with an operation of loading the cassette by the cassette loading holder, thereby blocking insertion of additional cassette after one cassette is already inserted without blocking an opening/closing operation of the opening/closing lid.

### BRIEF DESCRIPTION OF THE DRAWINGS

FIG. 1 is a sectional view illustrating a loading operation, an opening/closing operation of an opening/closing lid, and a function and control circuitry of a cassette double insertion blocking unit in a recording and/or reproducing apparatus according to an embodiment of the present invention, for a small cassette;

FIG. 2 is a sectional view illustrating a loading and ejecting operation and the function of the cassette double insertion blocking unit in the above recording and/or reproducing apparatus, for the small cassette;

FIG. 3 is a sectional view illustrating the loading operation, the opening/closing operation of the opening/closing lid, and a function and the control circuitry of the cassette double insertion blocking unit in the above recording and/or reproducing apparatus, for a large cassette;

FIG. 4 is a sectional view illustrating the loading and ejecting operation, and the function of the cassette double insertion blocking unit in the above recording and/or reproducing apparatus, for the large cassette;

FIGS. 5A, 5B are a perspective view illustrating detection of “open” or “closed” of the opening/closing lid in the above recording and/or reproducing apparatus;

FIG. 6 is a flowchart illustrating the functions of the cassette double insertion blocking unit in the above recording and/or reproducing apparatus;

FIG. 7 is a partially cutaway perspective view illustrating the cassette double insertion blocking unit in the above recording and/or reproducing apparatus; and

FIG. 8 is a perspective view showing the entire part of the above recording and/or reproducing apparatus with a top cover removed therefrom.

### DETAILED DESCRIPTION

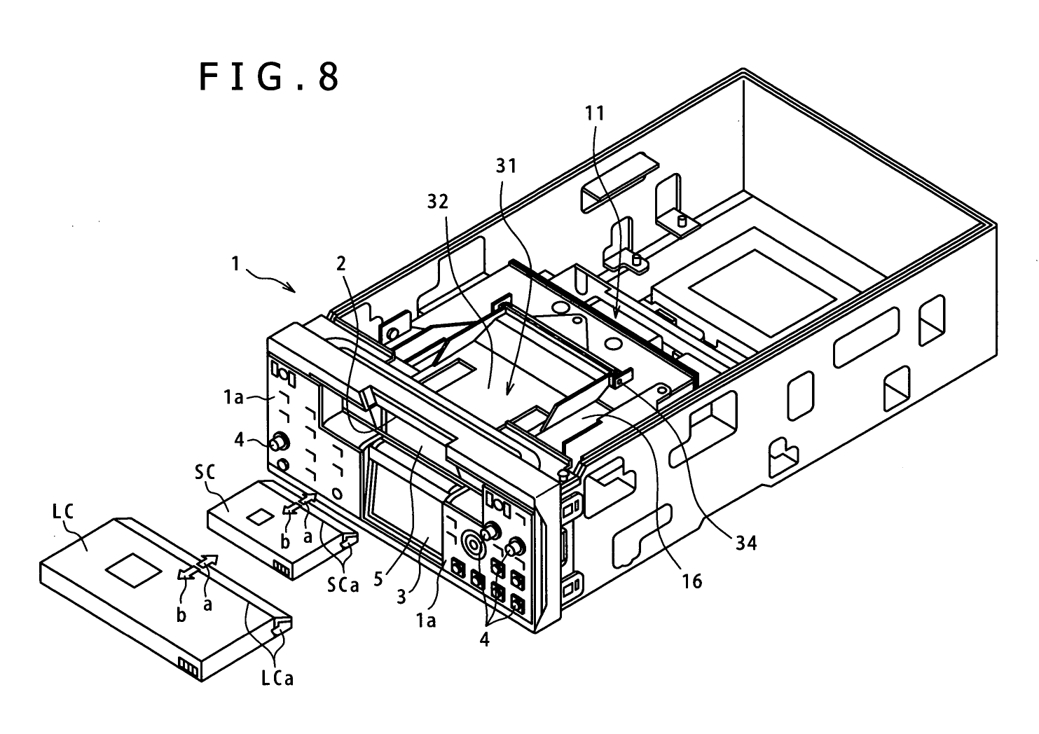

FIG. 8 shows a recording and/or reproducing apparatus 1 as a video editor (VTR for commercial use) according to an embodiment of the present invention with a top cover removed therefrom, and also two large and small magnetic tape cassette (hereafter, referred to as “cassette”) LC and SC. The large and small cassettes LC, SC have double-structured front lids LCa, SCa, at front, respectively.

In the upper middle of a front panel 1a of the recording and/or reproducing apparatus 1 is a horizontally extending cassette insertion slot 2 for selectively inserting and ejecting these cassettes LC, SC in directions pointed by arrows a, b. In the lower middle of the front panel la which is below the cassette insertion slot 2 is a rectangular display 3 such as a liquid crystal panel. On both sides of the display 3 of the front panel la are a plurality of controls 4, various indicators, and the like.

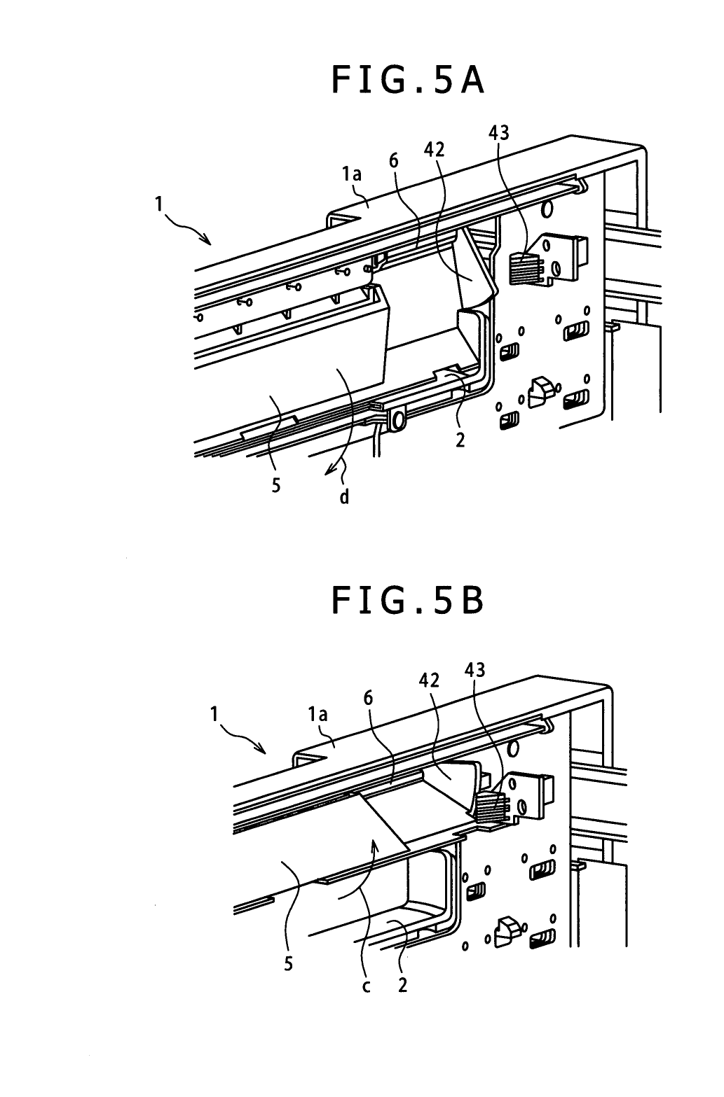

An opening/closing lid 5 is attached inward of the cassette insertion slot 2 of the front panel 1a. As shown in FIGS. 5A, 5B, the opening/closing lid 5 is designed as a so-called flapping structure (flapping type) by which the lid 5 is opened/closed inward in directions pointed by arrows c, d via a pair of horizontally extending (concentric) pivot pins 6 at both left/right positions of an upper end thereof.

As shown in FIG. 8, a cassette and magnetic tape loading mechanism 11 is accommodated at the position nearest to the front panel 1a, inside the recording and/or reproducing apparatus 1. The cassette and magnetic tape loading mechanism 11 includes a cassette loading mechanism section 11a that selectively loads the two, large and small cassettes LC, SC, and a magnetic tape loading mechanism section (not shown in the figure) that pulls out the magnetic tapes from the loaded cassettes LC, SC, for loading onto a rotary head drum, and then selectively records and/or reproduces data on and/or from the cassette LC, SC.

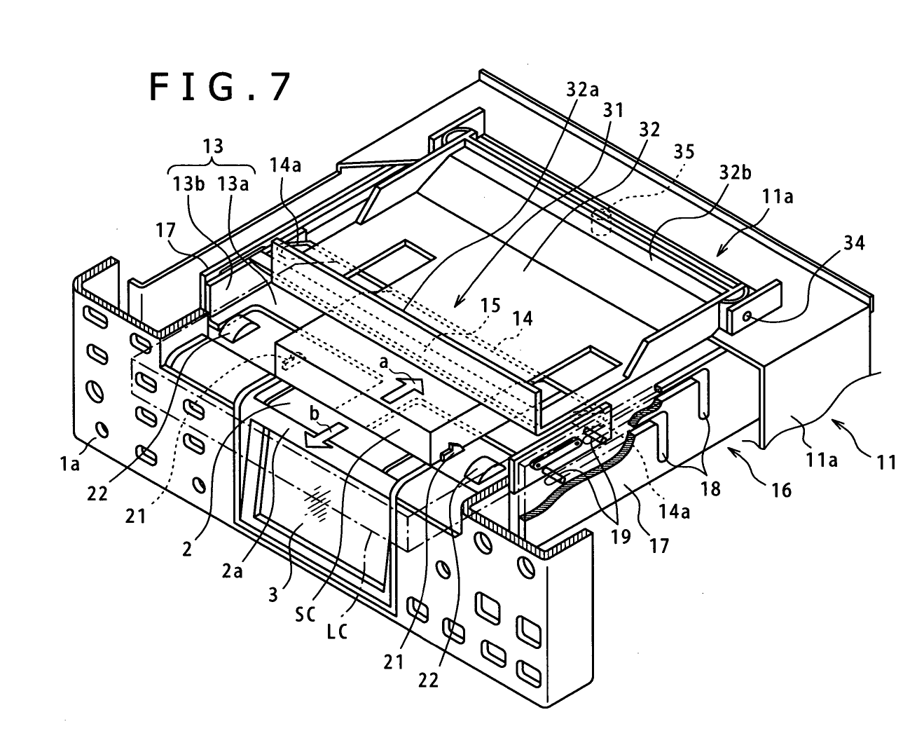

FIG. 7 shows the cassette loading mechanism section 11a of the cassette and magnetic tape loading mechanism 11, which is an internal part of the apparatus 1, by cutting away the upper side of the front panel 1a.

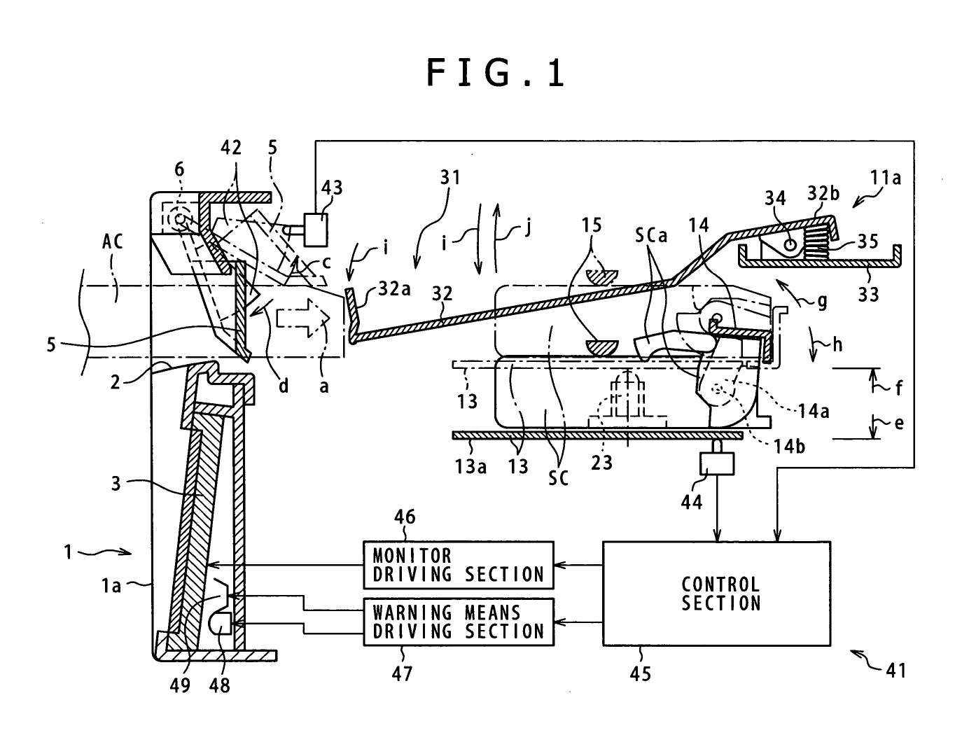

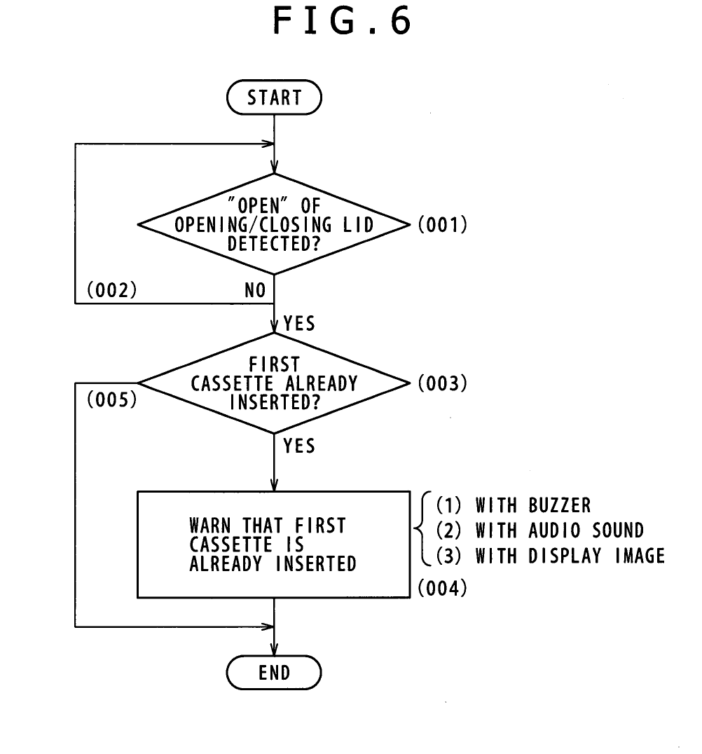

FIGS. 1 to 4 each show details of the cassette loading mechanism section 11awith a diagram of a control circuit block, and FIG. 6 shows a flowchart for the control circuit block.

Here, as shown in FIGS. 1 to 4, and 7, the cassette loading mechanism section 11aincludes a cassette loading holder 13. The cassette loading holder 13 is horizontally long, and approximately square-shaped without one of four sides, having a level bottom 13a and left/right sides 13b, and opens to above. The cassette loading holder 13 is configured to move in parallel in the front-back directions of the arrows a, b and in up-down directions pointed by arrows e, f.

At an end of the cassette loading holder 13 as viewed in the direction of the arrow a is a front lid opening/closing arm 14 being front lid opening/closing means common to the front lids LCa, SCa of the large and small cassettes LC, SC. Above the approximately middle of the cassette loading holder 13 (corresponding to the ceiling) as viewed in the directions of the arrows a, b are cassette double insertion blocking section, and a holding arm 15 being cassette holding means common to the large and small cassettes LC, SC and serving also as a cassette double insertion blocking section supporting portion. The front lid opening/closing arm 14 is approximately square-shaped without one of four sides in plan view. This front lid opening/closing arm 14 is attached by a pair of left/right pivot pins 14b at both ends 14a thereof as viewed lengthwise, between ends of the left/right sides 13b of the cassette loading holder 13 on a side as viewed in the direction of the arrow a, so as to be rotatable in up-down directions pointed by arrows g, h.

The cassette holding arm 15 is formed of a belt-shaped member. This cassette holding arm 15 spans between upper ends of the left/right sides 13b of the cassette loading holder 13, orthogonal with the directions of the arrows a, b at a position approximately in the middle as viewed in the directions of the arrows a, b, and parallel with the bottom 13a. The cassette holding arm 15 is forced downward by a resilient forcing member (not shown in the figure) parallelly to a predetermined height.

A cassette compartment 16 includes a pair of left/right guide plates 17 parallel with each other at both left/right side positions of the cassette loading holder 13. A pair of L-shaped guide grooves 18 is formed in each of these left/right guide plates 17. A pair of guide pins 19 is secured horizontally, at two positions as viewed in the directions of the arrows a, b, to the outer surface of each of the left/right sides 13b of the cassette loading holder 13. The pair of guide pins 19 on each of the left/right sides is slidably engaged with the corresponding one of the left/right pairs of L-shaped guide grooves 18.

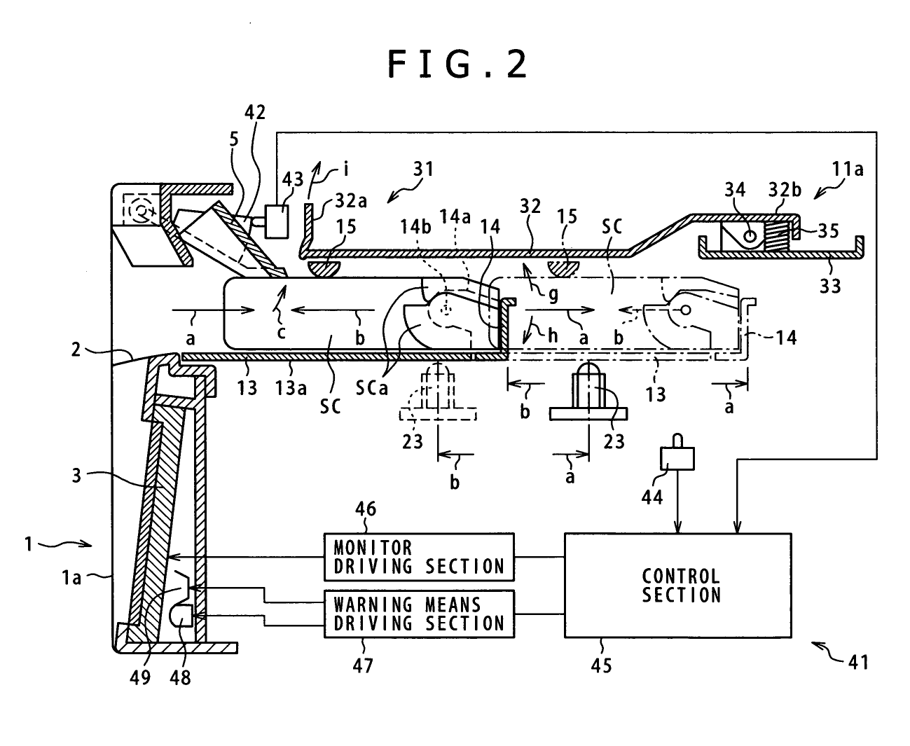

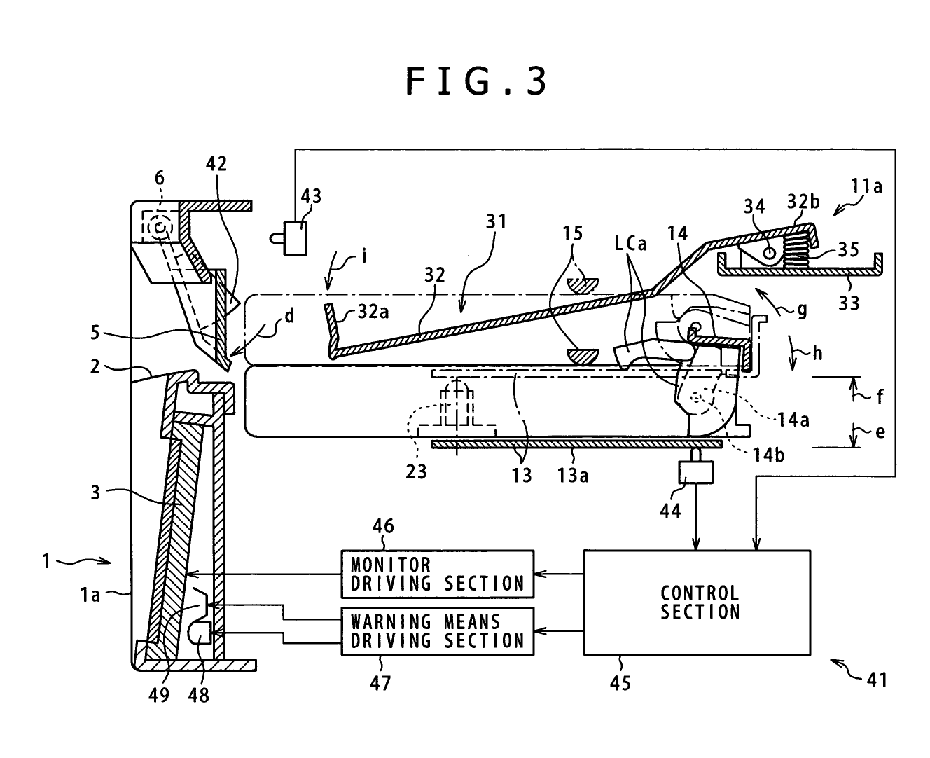

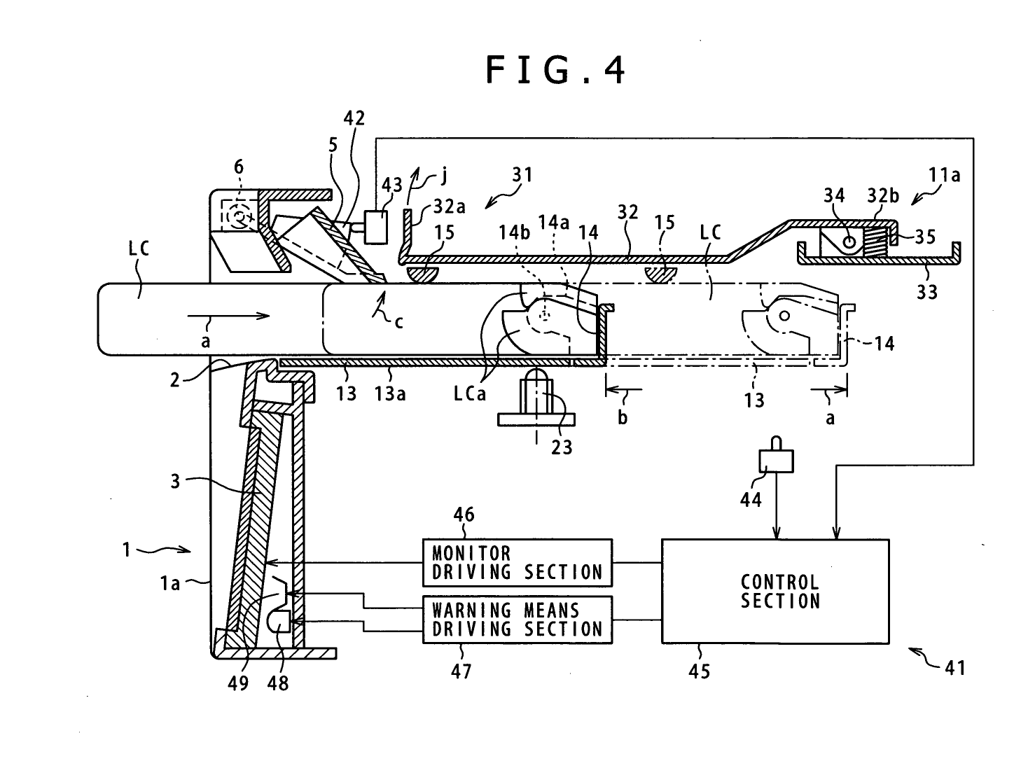

In this cassette compartment 16, when the cassette loading holder 13 is driven by driving section (not shown in the figure) to slide along the direction of the arrow a being a direction in which to insert the large or small cassette LC, SC, the guide pins 19 slide along the respective ones of the L-shaped guide grooves 18. The cassette loading holder 13 is pulled horizontally in the direction of the arrow a to an intermediate position indicated by dashed-dotted lines in FIGS. 2 and 4, from an ejecting position indicated by solid lines in FIGS. 2 and 4. Thereafter, the cassette loading holder 13 is lowered vertically in the direction of the arrow e down to a loading position indicated by solid lines in FIGS. 1 and 3, respectively.

Also, when the cassette loading holder 13 is driven by the driving section (not shown in the figure) to slide along the direction of the arrow b being a direction in which to eject the large or small cassette LC, SC, the guide pins 19 slide along the respective ones of the L-shaped guide grooves 18. The cassette loading holder 13 is driven so as to be lifted vertically in the direction of the arrow f up to the intermediate position indicated by the dashed-dotted lines in FIGS. 2 and 4 from the loading position indicated by the solid lines in FIGS. 1 and 3. Thereafter, the cassette loading holder 13 is pushed out horizontally in the direction of the arrow b to the ejecting position indicated by the solid lines in FIGS. 2 and 4, respectively.

As shown in FIG. 7, a pair of left/right small cassette insertion guides 21 is additionally provided retractably on a bottom 2a of the cassette insertion slot 2. These guides 21 guide the small cassette SC so that the cassette SC can be set in the middle of the cassette insertion slot 2. A pair of left/right large cassette detecting portions 22 retractably projects at left/right positions of the bottom 2a of this cassette insertion slot 2. These large cassette detecting portions 22 are configured such that when pushed down by the large cassette LC inserted into the cassette insertion slot 2, the large cassette detecting portions 22 cause the small cassette insertion guides 21 to move away down into the bottom 2a.

Furthermore, below the cassette loading holder 13 inside the cassette compartment 16, a pair of left/right reel tables 23 is disposed such that the reel-to-reel interval is variable.

Here, the operation of loading and unloading the large and small cassettes LC, SC will be described on the basis of the above configuration.

As shown by the solid line in FIG. 2 and a solid line in FIG. 7, the small cassette SC is inserted in the direction of the arrow a into the middle position above the bottom 13a of the cassette loading holder 13, while guided by the pair of left/right small cassette insertion guides 21 and pushing the opening/closing lid 5 open in the direction of the arrow c, and then held by the cassette holding arm 15 from above.

As shown by the solid line in FIG. 4 and also by an dashed-dotted line in FIG. 7, the large cassette LC is inserted in the direction of the arrow a into the middle position above the bottom 13a of the cassette loading holder 13, while pushing down the pair of left/right large cassette detecting portions 22 of the cassette insertion slot 2, thereby causing the pair of left/right small cassette insertion guides 21 to move away down, and while pushing the opening/closing lid 5 open in the direction of the arrow c. Furthermore, the large cassette LC is held by the cassette holding arm 15 from above.

After selectively inserted, the large and small cassettes LC, SC are pulled back horizontally in the direction of the arrow a to the pulling position indicated by the dashed-dotted lines in FIGS. 2 and 4, and thereafter loaded in the direction of the arrow e to the loading position indicated by the solid lines in FIGS. 1 and 3, respectively, by the cassette loading holder 13. During this operation, the front lids LCa, SCa of the large and small cassettes LC, SC are opened in the direction of the arrow g by the front lid opening/closing arm 14, respectively.

During the loading of the small cassette SC, the opening/closing lid 5 turns to return in the direction of the arrow d as shown by a solid line in FIG. 1 by its own weight or by a rotary forcing spring, on the way of the small cassette SC being pulled in the direction of the arrow a from the ejecting position indicated by the solid line to the pulling position indicated by the dashed-dotted line, in FIG. 2, to close the cassette insertion slot 2.

During the loading of the large cassette LC, the opening/closing lid 5 turns to return in the direction of the arrow d by its own weight or by the rotary forcing spring as shown by a solid line in FIG. 3, as the large cassette LC is lowered down in the direction of the arrow e from the pulling position indicated by the dashed-dotted line to the loading position indicated by the solid line, in FIG. 3, to close the cassette insertion slot 2.

During this operation, a pair of left/right reel tables (not shown in the figure) within the small cassette SC gets engaged with the pair of left/right reel tables 23 whose interval is automatically reduced, in the direction of the arrow e. Also, a pair of left/right reel tables (not shown in the figure) within the large cassette LC gets engaged with the pair of left/right reel tables 23 whose interval remains wide, in the direction of the arrow e.

After completion of the selective loading of the large and small cassettes LC, SC, the magnetic tapes within the large and small cassettes LC, SC are selectively loaded onto the rotary head drum (not shown in the figure) by the magnetic tape loading mechanism section (not shown in the figure) of the cassette and magnetic tape loading mechanism 11, for recording and/or reproducing of the data.

Note that the operation of selectively ejecting the large and small cassettes LC, SC is the reverse of the above-mentioned loading operation. When these large and small cassettes LC, SC are to be selectively ejected by the cassette loading holder 13 in the direction of the arrow b to the ejecting position indicated by the solid lines in FIGS. 2 and 4, respectively, the opening/closing lid 5 is caused to automatically open in the direction of the arrow c by an opening/closing mechanism (not shown in the figure) whereby these large and small cassettes LC, SC are ejected toward the cassette insertion slot 2.

Furthermore, various mode information, such as the selective loading of and the recording/reproducing of the data on and from the large and small cassettes LC, SC is successively displayed on the display 3.

Referring next to FIGS. 1 to 8, a cassette double insertion blocking unit 31 will be described.

This cassette double insertion blocking unit 31 includes cassette double insertion blocking section 32 disposed above the cassette loading holder 13 inside the cassette compartment 16, and a control circuit 41 disclosed in FIGS. 1 to 4.

The cassette double insertion blocking section 32 is made of a plate-shaped member such as a sheet metal or synthetic resin member. The cassette double insertion blocking section 32 extends along the directions of the arrows a, b being the cassette loading/ejecting directions. At an end as viewed in the direction of the arrow b, being a movable end of the cassette double insertion blocking section 32, is a cassette double insertion blocking portion 32a, which erects substantially squarely. This cassette double insertion blocking portion 32a is spaced apart from a path along which the opening/closing lid 5 opens/closes, in the direction of the arrow a being the loading direction. Therefore, the opening/closing lid 5 can freely open/close in the directions of the arrows c, d without interference with the cassette double insertion blocking portion 32a at all.

At an end as viewed in the direction of the arrow a, being the opposite end of the cassette double insertion blocking section 32, is a pivotally supporting portion 32b, which is attached to a supporting portion 33 such as an upper cover of the cassette compartment 16, so as to be rotatable in the directions pointed by arrows i, j being up-down directions, via a pivot 34. The cassette double insertion blocking section 32 is forced rotatably in the direction of the arrow i by a rotary forcing spring 35 and/or its own weight, and its rotation in the direction of the arrow i is stopped by a rotation regulating portion (not shown in the figure) formed with the cover of the cassette compartment 16 or the like, at a cassette double insertion blocking position indicated as a state in which the section 32 slopes down as viewed from the front of the apparatus in FIGS. 1 and 3. Note that the cassette double insertion blocking portion 32a of the cassette double insertion blocking section 32 has a width larger than that of the small cassette SC and smaller than that of the cassette insertion slot 2.

In the control circuit 41, switches, such as an opening/closing lid “open” detecting switch 43 that is operated by a fan-shaped switch operating portion 42 provided at an end of the opening/closing lid 5, and a cassette loading completion detecting switch 44 that detects the cassette loading holder 13 having reached the loading position, are connected to a control section 45. The control section 45 is connected to the display 3 being a monitor, by a monitor driving section 46. Also, the control section 45 is connected to warning means, such as a buzzer (sound generating means) 48, a speaker (speech generating means) 49, and the like, by a warning means driving section 47.

The cassette double insertion blocking unit 31 is configured as described above. When the cassette loading holder 13 is returned in the direction of the arrow b to the ejecting position as shown in FIGS. 2 and 4, the cassette double insertion blocking section 32 becomes substantially horizontal as placed on the cassette holding arm 15 of the cassette loading holder 13, with the cassette double insertion blocking portion 32a escaped to an upper position inward of the cassette insertion slot 2.

Next, as shown by the solid lines in FIGS. 1 and 3, when the large and small cassettes LC, SC are selectively inserted into the cassette loading holder 13 through the cassette insertion slot 2 in the direction of the arrow a, the opening/closing lid “open” detecting switch 43 turns on, whereby the control section 45 detects the insertion of the cassettes.

When the large and small cassettes LC, SC are lowered by the cassette loading holder 13 to the loading position in the direction of the arrow e from the pulling position as shown by the solid lines in FIGS. 1 and 3, the cassette double insertion blocking section 32 gets lowered in the direction of the arrow i to the cassette double insertion blocking position by the rotary forcing spring 35 or the like, in synchronization with the lowering of the cassette holding arm 15 of the cassette loading holder 13, respectively. And the cassette double insertion blocking portion 32a at the distal end is moved inward of the cassette insertion slot 2. Note that the sequential movement of insertion and loading of the small cassette SC into the cassette loading holder 13 is shown in FIGS. 2 and 1, and the large cassette LC in FIGS. 4 and 3.

Meanwhile, as shown by the solid lines in FIGS. 1 and 3, when the large and small cassettes LC, SC are selectively loaded to the loading position by the cassette loading holder 13, the cassette loading detecting switch 44 turns on, whereby the control section 45 detects completion of the loading of the cassettes.

And if, during the selective loading or after completion of the selective loading of the large and small cassettes LC, SC, a cassette double insertion operation is performed, such as an operation of erroneously inserting another cassette AC into the cassette insertion slot 2 while pushing the opening/closing lid 5 open in the direction of the arrow c, the doubly inserted cassette AC stops by collision with the cassette double insertion blocking portion 32a at the distal end of the cassette double insertion blocking section 32. As a result, it becomes difficult to insert the cassette AC further, whereby the cassette double insertion is blocked.

Therefore, the user may recognize clearly that his/her operation of inserting the cassette AC is a double insertion operation. Additionally, during the cassette double insertion, the opening/closing lid 5 can be pushed open freely without force in the direction of the arrow c by the cassette AC, and thus the opening/closing lid 5 should in no way be broken.

Meanwhile, during the cassette double insertion, as shown by an dashed-dotted line in FIG. 1, the opening/closing lid “open” detecting switch 43 is turned on by the switch operating portion 42 of the opening/closing lid 5 pushed open by such another cassette AC in the direction of the arrow c, whereby the cassette double insertion information is inputted to the control section 45.

In response thereto, the control section 45 causes the warning means driving circuit 47 to perform an operation such as sounding a buzzer 48 or a speaker 49, whereby the user is warned of his/her cassette double insertion operation.

Also, the control section 45 activates the monitor driving section 46 such that the display 3 gives a display warning that the user is performing a cassette double insertion operation.

The cassette double insertion blocking control function performed by the control section 41 is summarized, by reference to a flowchart of FIG. 6, as follows:
(1) When a cassette double insertion operation is performed, the control section 41 determines whether or not “open” of the opening/closing lid 5 is detected (001);
(2) If NO, the control section 41 loops back (002);
(3) If YES, the control section 41 determines whether or not a first cassette is already inserted (003);
(4) If the first cassette is already inserted (YES), a warning operation is performed (004), such as
   (4-1) warning with sound of the buzzer 48;
   (4-2) warning with audio sound from the speaker 49; or
   (4-3) warning with a display image by the display 3; and
(5) If the first cassette is not inserted, the process ends immediately (005).

The recording and/or reproducing apparatus 1 according to an embodiment of the present invention including thus configured cassette double insertion blocking unit has advantages as follows:

If, during the selective loading or after completion of the selective loading of the large and small cassettes LC, SC, a cassette double insertion operation is performed, such as the operation of inserting another cassette AC into the cassette insertion slot 2 while pushing the opening/closing lid 5 open as shown by the dashed-dotted line in FIG. 1, a warning to the user for blocking of the cassette double insertion is given definitely. Thus, the user, fully aware that his/her operation is a double insertion operation, can stop such cassette double insertion immediately and safely.

Meanwhile, during the cassette double insertion, the opening/closing lid 5 is allowed to open in the direction of the arrow c with no force at all, and thus there is no likelihood of inconvenience that the opening/closing lid 5 gets broken due to forcible opening by the cassette double insertion. Hence, reliability is extremely high.

Note that if the cassette double insertion blocking section 32 is made of a high strength sheet metal, the cassette double insertion can be blocked more strongly, which hence is also advantageous in, e.g., blocking insertion of rigid extraneous objects and the like other than cassettes.

The recording and/or reproducing apparatus according to an embodiment of the present invention can prevent double insertion of cassettes without blocking the opening/closing operation of the opening/closing lid, and thus can further prevent inconvenience such as a mechanical breakdown of the opening/closing lid by cassette double insertion.

While the embodiment of the present invention has been described in the foregoing, the present invention is not limited thereto, but may be modified in various ways on the basis of its technical ideas.

In the above embodiment, a magnetic tape cassette whose recording medium is a magnetic tape was described. Alternatively, a disc cassette whose recording medium is a disc may also be used.

It should be understood by those skilled in the art that various modifications, combinations, sub-combinations and alterations may occur depending on design requirements and other factors insofar as they are within the scope of the appended claims or the equivalents thereof.

1. A recording and/or reproducing apparatus comprising:
a cassette insertion slot formed at a front panel;
an opening/closing lid for opening/closing the cassette insertion slot;
a cassette compartment including a cassette loading holder for loading and unloading a cassette inserted through the cassette insertion slot while pushing the opening/closing lid open inward, by moving between a cassette loading position and a cassette ejecting position along a substantially L-shaped path extending in a horizontal direction and a vertical direction; and
cassette double insertion blocking means, disposed in the cassette compartment, and being moved to a cassette double insertion blocking position inward of the cassette insertion slot in synchronization with an operation of loading the cassette by the cassette loading holder, thereby blocking insertion of additional cassette after one cassette is already inserted without blocking an opening/closing operation of the opening/closing lid.

2. The recording and/or reproducing apparatus according to claim 1, wherein
the cassette double insertion blocking means is configured so as to cause a cassette double insertion blocking portion formed on a side in a cassette ejecting direction to move between the cassette double insertion blocking position set inward of a path along which the opening/closing lid of the cassette insertion slot opens/closes and an escaping position in a direction different from a loading direction of the cassette loading holder.

3. The recording and/or reproducing apparatus according to claim 2, wherein
the cassette double insertion blocking means is pivotally supported at a pivot portion on a front side thereof in the loading direction of the cassette;
the cassette double insertion blocking portion of the cassette double insertion blocking means is placed on a cassette double insertion blocking means supporting portion disposed on a portion corresponding to a ceiling of the cassette loading holder; and
the cassette double insertion blocking portion of the cassette double insertion blocking means is rotated between the cassette double insertion blocking position inward of the cassette insertion slot and the escaping position moved away from the cassette insertion slot, in synchronization with loading or unloading of the cassette loading holder along the substantially L-shaped path extending in the horizontal direction and in the vertical direction.

4. The recording and/or reproducing apparatus according to claim 3, wherein
the cassette double insertion blocking means supporting portion is configured to include a cassette forcing-down arm for forcing down the cassette inserted into the cassette loading holder from above.

5. The recording and/or reproducing apparatus according to claim 3, further comprising:
forcing-down means for forcing down the cassette double insertion blocking portion of the cassette double insertion blocking means onto the cassette double insertion blocking means supporting portion constantly in a resilient manner.

6. The recording and/or reproducing apparatus according to claim 5, further comprising:
a rotation regulating portion for stopping the cassette double insertion blocking portion of the cassette double insertion blocking means at the cassette double insertion blocking position, when the cassette loading holder is moved to the cassette loading position from the cassette ejecting position.

7. The recording and/or reproducing apparatus according to claim 3, wherein
the cassette double insertion blocking means is made of a sheet metal.

8. The recording and/or reproducing apparatus according to claim 1, further comprising:
warning issuing means for issuing a warning to make a user aware of a cassette double insertion operation, in a case a second cassette is inserted into the cassette insertion slot when a first cassette is already loaded to the cassette loading position, or during loading of the first cassette.

9. The recording and/or reproducing apparatus according to claim 8, wherein
the warning by the warning issuing means is issued on the basis of detection by detecting means of if the second cassette is inserted into the cassette insertion slot when the first cassette is already loaded to the cassette loading position or during loading of the first cassette.

10. The recording and/or reproducing apparatus according to claim 9, wherein
the detecting means detects if the opening/closing lid for opening/closing the cassette insertion slot is open.

11. The recording and/or reproducing apparatus according to claim 8, wherein
the warning issuing means is a buzzer.

12. The recording and/or reproducing apparatus according to claim 8, wherein
the warning issuing means is audio sound issuing means.

13. The recording and/or reproducing apparatus according to claim 8, wherein
the warning issuing means is a display image.

14. A recording and/or reproducing apparatus comprising:
a cassette insertion slot formed at a front panel;
an opening/closing lid for opening/closing the cassette insertion slot;
a cassette compartment including a cassette loading holder for loading and unloading a cassette inserted through the cassette insertion slot while pushing the opening/closing lid open inward, by moving between a cassette loading position and a cassette ejecting position along a substantially L-shaped path extending in a horizontal direction and a vertical direction; and
cassette double insertion blocking section, disposed in the cassette compartment, and being moved to a cassette double insertion blocking position inward of the cassette insertion slot in synchronization with an operation of loading the cassette by the cassette loading holder, thereby blocking insertion of additional cassette after one cassette is already inserted without blocking an opening/closing operation of the opening/closing lid.
